(19) United States
(12) Patent Application Publication
(10) Pub. No.: US 2004/0140583 A1
(43) Pub. Date: Jul. 22, 2004

(54) Method and apparatus for the continuous production of rubber mixtures

(75) Inventor: Reinhard Uphus, Hannover (DE)

Correspondence Address: HENRY M FEIEREISEN, LLC, 350 FIFTH AVENUE, SUITE 4714, NEW YORK, NY, 10118, US

(73) Assignee: BERSTORFF GMBH, Hannover (DE)

(21) Appl. No.: 10/754,671

(22) Filed: Jan. 9, 2004

Related U.S. Application Data
(63) Continuation of application No. PCT/EP02/07474, filed on Jul. 5, 2002.

(30) Foreign Application Priority Data
Jul. 10, 2001 (DE) 101 34 701.4

(51) Int. Cl. B29C 47/38; B29C 47/40; B29C 47/60

(52) U.S. Cl. 264/138; 264/349; 264/211.21; 264/211.23; 425/208

(57) ABSTRACT

In a method and apparatus for the continuous production of rubber mixtures, rubber is introduced into a short-screw extruder for subsequent plasticization. The thus plasticized rubber is then fed through intervention of a gear pump to a twin-screw extruder at a predetermined temperature and predetermined volume flow:

### CROSS-REFERENCES TO RELATED APPLICATIONS

This application is a continuation of prior filed copending PCT International application no. PCT/EP02/07474, filed Jul. 5, 2002, which designated the United States and on which priority is claimed under 35 U.S.C. §120, the disclosure of which is hereby incorporated by reference.

This application claims the priority of German Patent Application, Serial No. 101 34 701.4, filed Jul. 10, 2001, pursuant to 35 U.S.C. 119(a)-(d), the disclosure of which is incorporated herein by reference.

### BACKGROUND OF THE INVENTION

The present invention relates to a method for the continuous production of rubber mixtures by means of a twin-screw extruder. The present invention also relates to an apparatus for carrying out the method.

Heretofore, rubber mixtures have almost exclusively been made discontinuously in so-called internal mixers, although attempts were undertaken to compound rubber mixtures continuously on twin-screw extruders (DE-Z. Gummi Fasern Kunststoffe [Rubber Fibers Plastics], Capelle, G. “Kont. Herstellung von Kautschukmischungen auf Zweischnecken-Extrudern” [Continuous Production of Rubber Mixtures on Twin-screw Extruders], 49 (1996) 6, pages 470473, or Uphus, Skibba, Schuster “Cont. Mixing of Powder Rubber on Twin-Screw Extruder”, 4/2000, or German Pat. No. DE 40 39 943.

All these approaches have in common the following shortcomings:

in order to be able to continuously meter and maintain the intended formulation, rubber has to be prepared in a form that is suitable for metering. In other words, the rubber has to be prepared in powdery form or granular form etc.;

this normally entails an expensive preparation step, like grinding of the rubber bale and separation of the granules, or other preparation processes such as, e.g., powder rubber production, gas phase EPDM)

the metering steps requires also a fairly expensive metering system;

not all rubber types, also in combination with soot or silicic acid as fillers, can be made available in this form;

rubber mixtures have significantly higher viscosities in comparison to plastic melts, resulting in generation of considerable heat as a consequence of inner friction (dissipation) that may damage the mixture. Therefore, the rotation speed and thus the throughput of the assembly must be kept small. This adversely affects the overall efficiency of the assembly;

the limit of the available torque is quickly reached, when small rotation speeds are involved.

The material is normally fed cold into the twin-screw extruder. Therefore, a major part of the drive torque has to be used for heating the rubber mixture from e.g. 20° C. to 100° C. The typical inner mixer is normally dimensioned at a specific drive energy of, e.g., about 0.2 kWh/kg to compound a typical rubber mixture. When assuming an average specific heat capacity of 2000 J/(kg k) for rubber, the heating step for plasticizing requires about 0.0444 kWh/kg, i.e. about 22%. This means also about 22% of the available torque at preset rotation speed.

It would therefore be desirable and advantageous to provide an improved method and apparatus for the continuous production of rubber mixtures to obviate prior art shortcomings and to reduce energy consumption as well as costs.

### SUMMARY OF THE INVENTION

According to one aspect of the present invention, a method for the continuous production of rubber mixtures includes the steps of plasticizing rubber in a short-screw extruder to prepare plasticized rubber, and feeding plasticized rubber through intervention of a gear pump to a twin-screw extruder at a predetermined temperature and predetermined volume flow. Suitably, the gear pump and the short-screw extruder can be separately powered and controlled by a suitable drive system.

The present invention resolves prior art problems by separating the twin-screw extruder from the actual rubber plasticizing step which is realized by the short-screw extruder, so that the energy consumption is overall reduced as the twin-screw extruder is not required to realize plasticization of the rubber mixture.

According to another feature of the present invention, the rubber can be cut in the form of strips from a bale of rubber as starting material.

According to another aspect of the present invention, an apparatus for the continuous production of rubber mixtures includes a short-screw extruder having an inlet for introduction of material to be extruded, a gear pump having an inlet, which is connected to the short-screw extruder, and an outlet, a twin-screw extruder having an inlet connected directly to the outlet of the gear pump, a drive system for separately operating the gear pump and the short-screw extruder. Suitably, the drive system includes a first drive for operating the gear pump, and a second drive for operating the short-screw extruder.

According to another feature of the present invention, the outlet of the gear pump is disposed in closed proximity to the inlet of the twin-screw extruder so that the outer diameter of the teeth of the gear pump is spaced at a slight distance from the outer diameter of the teeth of the screws of the twin-screw extruder.

The present invention achieves many advantages: The use of conventional bale of rubber is now possible, without requiring previously typically used rubber cleavers that cut the rubber in relatively thick strips. In other words, there is no need to treat the rubber with separating means and there is no need to use rubber in powdery form or granular form which is expensive. Of course, other forms of raw materials may be used such as powder, granulate or strips. The intervention of the gear pump, which can be operated substantially independent from counterpressure, a constant volume flow, and also constant mass flow in case of constant density, can be fed to the twin-screw extruder to comply with the desired formulation.

As the short-screw extruder and the gear pump are operated separately, the temperature of the plasticized rubber can be varied over a wide control range through modifying the extruder speed, when the pump speed is set. In other words, the plasticizing output is assumed by the combination of extruder and gear pump so that the power required hereby is again made available to the twin-screw extruder. As a result, the throughput is higher than before, when the rotation speed is constant, or a same throughput as before can be realized at reduced rotation speed.

Some applications, such as, e.g., silanization of mixtures containing silicic carbon, require execution of a chemical reaction, e.g. at 140° C. This mass temperature may now be applied by the short-screw extruder. The retention time of the mass in the twin-screw extruder can then be realized completely at reaction temperature.

Another advantage is the ability to shorten the overall length of the twin-screw extruder by the length of the heat-up section.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a principal configuration of an apparatus for the continuous production of rubber mixture in accordance with the present invention; and

FIG. 2 is a schematic fragmentary illustration, on an enlarged scale, of the apparatus of FIG. 1, taken along the line II-II to depict the short-screw extruder and attached gear pump.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

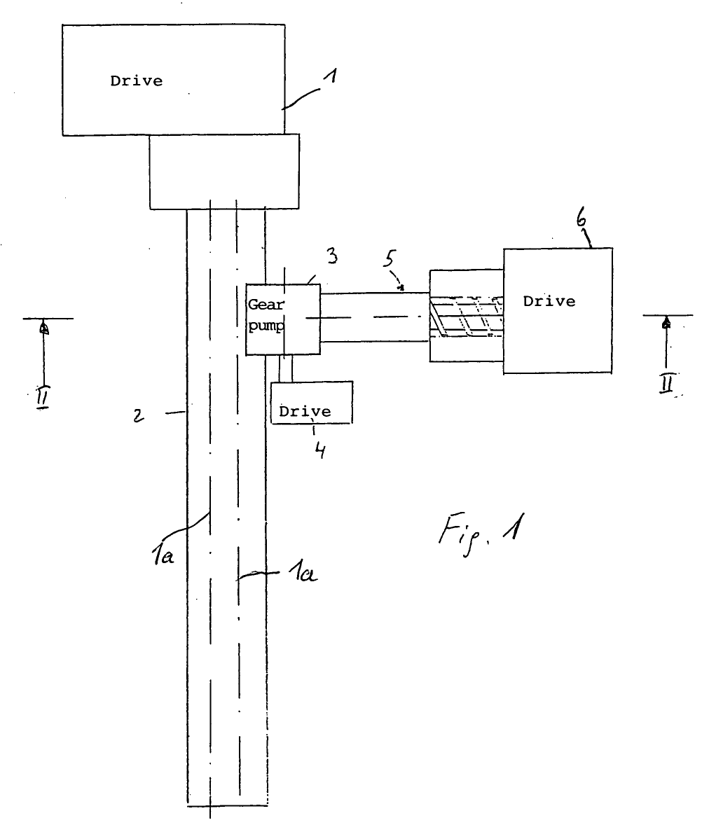

Turning now to the drawing, and in particular to FIG. 1, there is shown a schematic illustration of a principal configuration of an apparatus for the continuous production of a rubber mixture in accordance with the present invention, including a twin-screw extruder 2 powered by a conventional drive 1 and includes two screws 1a, indicated by dash-dotted lines. It will be appreciated by persons skilled in the art that the twin-screw extruder 2 must contain much mechanical apparatus which does not appear in the foregoing Figures, e.g. extruder head in a forward portion thereof. However, this apparatus, like much other necessary apparatus, is not part of the invention, and has been omitted from the Figures for the sake of simplicity.

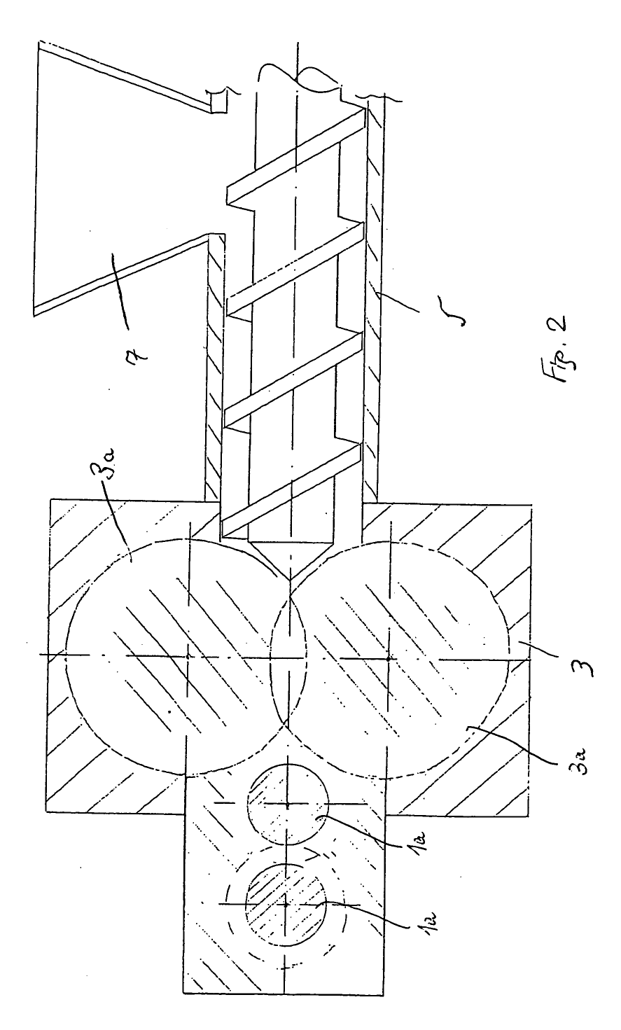

The twin-screw extruder 2 has an inlet port for attachment of a gear pump 3 which is connected to a short-screw extruder 5 and has two meshing gear wheels 3a (FIG. 2) which contrarotate to advance the rubber material. The gear pump 3 is powered by a drive 4 whereas the short-screw extruder 5 is powered by a drive 6. The space between the screws 1a of the twin-screw extruder 2 and the gear pump 3 is hereby held as small as possible. In other words, the outer diameter of the teeth of the gear pump 3 extends at a very slight distance from the outer diameter of the screws 1a of the twin-screw extruder 2. This is also shown in FIG. 2, which shows a schematic fragmentary illustration, on an enlarged scale of the apparatus of FIG. 1, taken along the line II-II, to depict the combination of the gear pump 3 and the short-screw extruder 5. As a result of the close proximity between the outer diameter of the teeth of the gear pump 3 and the outer diameter of the screws 1a of the twin-screw extruder 2, cleaning can be realized in a much simpler fashion, in the event a change in mixture is desired.

The apparatus according to the invention operates as follows: a rubber mixture, e.g. in the form of strips cut from a rubber bale as starting material, is introduced via a funnel-shaped inlet 7 into the short-screw extruder 5 for subsequent plasticization of the rubber material. The temperature of the plasticized rubber can hereby be varied over a wide range through interaction between the short-screw extruder 5 and the gear pump 3 and through individual control of operation of the short-screw extruder 5 and the gear pump 3, before the plasticized rubber is transferred to the twin-screw extruder 2. The thus adjusted rubber mass is then mixed in the twin-screw extruder 2 in a manner known per se with other additives such as, e.g., soot or oil.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for the continuous production of rubber mixtures, comprising the steps of:
plasticizing rubber in a short-screw extruder to prepare plasticized rubber; and
feeding plasticized rubber through intervention of a gear pump to a twin-screw extruder at a predetermined temperature and predetermined volume flow.

2. The method of claim 1, and further comprising the step of providing a drive system for separately powering and controlling the gear pump and the short-screw extruder.

3. The method of claim 1, wherein the rubber is cut in the form of strips from a rubber bale as starting material.

4. Apparatus for the continuous production of rubber mixtures, comprising:
a short-screw extruder having an inlet for introduction of material to be extruded;
a gear pump having an inlet, which is connected to the short-screw extruder, and an outlet;
a twin-screw extruder having an inlet connected directly to the outlet of the gear pump; and
a drive system for separately operating the gear pump and the short-screw extruder.

5. The apparatus of claim 4, wherein the drive system includes a first drive for operating the gear pump, and a second drive for operating the short-screw extruder.

6. The apparatus of claim 4, wherein the gear pump has a tooth system defined by an outer diameter, and the twin-screw extruder has two screws with outer teeth defined by an outer diameter, wherein the outlet of the gear pump is disposed in closed proximity to the inlet of the twin-screw extruder so that the outer diameter of the tooth system of the gear pump is spaced at a slight distance to the outer diameter of the outer teeth of the screws of the twin-screw extruder.
